(19) United States
(12) Patent Application Publication
(10) Pub. No.: US 2025/0211373 A1
(43) Pub. Date: Jun. 26, 2025

(54) COMMUNICATION PROTOCOL CONVERSION METHOD AND APPARATUS FOR DETECTING COMMUNICATION PROTOCOL CONVERSION ERRORS BETWEEN HETEROGENEOUS AUTOMOBILE COMMUNICATION NETWORKS

(71) Applicant: TELECHIPS INC., Seongnam-si (KR)

(72) Inventor: Min Ju YOON, Hwaseong-si (KR)

(21) Appl. No.: 18/963,223

(22) Filed: Nov. 27, 2024

(30) Foreign Application Priority Data
Dec. 22, 2023 (KR) 10-2023-0189975

(51) Int. Cl. H04L 1/20; H04L 67/12

(52) U.S. Cl. CPC H04L 1/201; H04L 67/12

(57) ABSTRACT

Disclosed are a communication protocol conversion method and apparatus for detecting communication protocol conversion errors between heterogeneous automobile communication networks. The communication protocol conversion method includes: storing a copy of a first communication network frame received, converting the received first communication network frame into a second communication network frame through a first conversion module, inversely converting the converted second communication network frame into a first communication network frame through a second conversion module, comparing the stored copy of the first communication network frame and the inversely converted first communication network frame, and detecting conversion errors between the first and second communication network frames according to a comparison result.

### CROSS REFERENCE TO RELATED APPLICATION

This application claims the benefit of priority under 35 U.S.C. § 119 (a) to Korea Patent Application No. 10-2023-0189975, filed with the Korean Intellectual Property Office on Dec. 22, 2023, which is hereby incorporated by reference in its entirety.

### BACKGROUND

### Field

The present disclosure relates to a communication protocol conversion technology for a vehicle gateway device, and more particularly, to a technology for detecting communication protocol conversion errors between an Ethernet frame and a non-Ethernet frame (e.g., CAN frame, LIN frame, FlexRay frame, etc.) in heterogeneous automobile communication networks.

### Description of Related Art

In an environment where a vehicle backbone network is comprised of an Ethernet network and multiple non-Ethernet networks (e.g., CAN frame network, LIN frame network, FlexRay frame network, etc.) are connected to the backbone network via a gateway device, it is necessary for a specific electronic control unit (ECU) belonging to a non-Ethernet network to pass through the Ethernet network which is the backbone network, in order to communicate with an ECU belonging to another non-Ethernet network.

To this end, a communication protocol conversion apparatus for the gateway device performs communication protocol conversion between the Ethernet network and the non-Ethernet network. A communication protocol conversion apparatus for a transmitting side gateway converts a non-Ethernet frame received from the non-Ethernet network into an Ethernet frame before carrying it to the Ethernet network. Conversely, a communication protocol conversion apparatus for a receiving side gateway converts an Ethernet frame received from the Ethernet network into a non-Ethernet frame before carrying it to the non-Ethernet network.

Since conventional communication protocol conversion apparatuses only perform conversion between heterogeneous communication protocols but do not take conversion error detection into consideration, they provide no safety measures against conversion errors.

### SUMMARY

Embodiments of the present disclosure provide a communication protocol conversion method and apparatus for detecting communication protocol conversion errors between heterogeneous automobile communication networks, in order to prevent vehicle malfunction caused by erroneous frames and an unnecessary waste of network bandwidth, by detecting frame conversion errors arising from temporary or permanent malfunction in conversion between heterogeneous automobile communication networks and therefore preventing any possible transmission of erroneous frames.

However, the problems to be solved by the present disclosure are not limited thereto, and may be variously extended even in an environment within a range not departing from the spirit and scope of the present disclosure.

An embodiment of the present disclosure provides a communication protocol conversion method for detecting communication protocol conversion errors between heterogeneous automobile communication networks, performed by a communication protocol conversion apparatus, the method comprising: storing a copy of a first communication network frame received; converting the received first communication network frame into a second communication network frame through a first conversion module; inversely converting the converted second communication network frame into a first communication network frame through a second conversion module; comparing the stored copy of the first communication network frame and the inversely converted first communication network frame; and detecting conversion errors between the first and second communication network frames according to a comparison result.

If the first communication network frame is a non-Ethernet frame, then the second communication network frame is an Ethernet frame, and if the first communication network frame is an Ethernet frame, then the second communication network frame is a non-Ethernet frame.

The non-Ethernet frame includes at least one of a CAN (controller area network) frame, a LIN (local interconnect network) frame, and a FlexRay frame.

In the detecting of conversion errors, if the comparison result shows that the stored copy of the first communication network frame and the inversely converted first communication network frame do not match, a conversion error notification is issued.

In the detecting of conversion errors, if the comparison result shows that the stored copy of the first communication network frame and the inversely converted first communication network frame match, the converted second communication network frame is outputted.

In the detecting of conversion errors, errors arising when the first conversion module or the second conversion module reassembles control information (PDU; Protocol Data Unit) format of an input frame into control information (PDU) format of an output frame are detected.

Another embodiment of the present disclosure provides a communication protocol conversion apparatus for detecting communication protocol conversion errors between heterogeneous automobile communication networks, the apparatus comprising: an input/output module that receives or transmits a communication network frame, between the heterogeneous automobile communication networks; a first conversion module that converts a first communication network frame into a second communication network frame, between the heterogeneous automobile communication networks; a second conversion module that converts the second communication network frame into the first communication network frame, between the heterogeneous automobile communication networks; a memory that stores one or more programs; and a processor that executes the one or more stored programs; wherein the processor stores a copy of the first communication network frame received through the input/output module, converts the received first communication network frame into the second communication network frame through the first conversion module, inversely converts the converted second communication network frame into a first communication network frame through the second conversion module, compares the stored copy of the first communication network frame and the inversely converted first communication network frame, and detects conversion errors between the first and second communication network frames according to a comparison result.

If the first communication network frame is a non-Ethernet frame, then the second communication network frame is an Ethernet frame, and if the first communication network frame is an Ethernet frame, then the second communication network frame is a non-Ethernet frame.

The non-Ethernet frame includes at least one of a CAN (controller area network) frame, a LIN (local interconnect network) frame, and a FlexRay frame.

If the comparison result shows that the stored copy of the first communication network frame and the inversely converted first communication network frame do not match, the processor issues a conversion error notification.

If the comparison result shows that the stored copy of the first communication network frame and the inversely converted first communication network frame match, the processor outputs the converted second communication network frame.

The processor detects errors arising when the first conversion module or the second conversion module reassembles control information (PDU; Protocol Data Unit) format of an input frame into control information (PDU) format of an output frame.

The disclosed technology may have the following effects. However, since it does not mean that a specific embodiment should include all of the following effects or only the following effects, it should not be understood that the scope of the rights of the disclosed technology is limited thereby.

Embodiments of the present disclosure can prevent vehicle malfunction caused by erroneous frames and an unnecessary waste of network bandwidth, by detecting frame conversion errors arising from temporary or permanent malfunction in conversion between heterogeneous automobile communication networks and therefore preventing any possible transmission of erroneous frames.

Embodiments of the present disclosure can detect communication protocol conversion errors between an Ethernet frame and a non-Ethernet frame (e.g., CAN frame, LIN frame, FlexRay frame, etc.) in heterogeneous automobile communication networks.

### BRIEF DESCRIPTION OF THE DRAWING

FIG. 1 is a view showing an operation of a gateway between heterogeneous automobile communication networks that includes a communication protocol conversion apparatus according to an embodiment of the present disclosure.

FIG. 2 is a view showing an operation of detecting conversion errors when converting a non-Ethernet frame into an Ethernet frame by a communication protocol conversion apparatus according to an embodiment of the present disclosure.

FIG. 3 is a view showing an operation of detecting conversion errors when converting an Ethernet frame into a non-Ethernet frame by a communication protocol conversion apparatus according to an embodiment of the present disclosure.

FIG. 4 is a flowchart showing a communication protocol conversion method for detecting communication protocol conversion errors between heterogeneous automobile communication networks according to an embodiment of the present disclosure.

FIG. 5 is a configuration diagram of a communication protocol conversion apparatus for detecting communication protocol conversion errors between heterogeneous automobile communication networks according to an embodiment of the present disclosure.

### DETAILED DESCRIPTION

The present disclosure can make various changes and have various embodiments, and specific embodiments will be illustrated in the drawings and described in detail. However, this is not intended to limit the present disclosure to a specific embodiment, and it should be understood to include all changes, equivalents, or substitutes included in the spirit and scope of the present disclosure. In describing the present disclosure, if it is determined that a detailed description of a related known technology may obscure the gist of the present disclosure, the detailed description thereof will be omitted.

Terms such as first and second may be used for describing various components, but the components should not be limited by the terms. These terms are used only for the purpose of distinguishing one component from another component.

The terms used in the present disclosure are only used to describe specific embodiments, and are not intended to limit the present disclosure. The terms used in the present disclosure may be currently widely used general terms in consideration of the functions in the present disclosure but may vary depending on the intents of those skilled in the art, precedents or the advent of new technology. Additionally, in certain cases, there may be terms that the applicant selects arbitrarily. In this case, their meanings are described in detail in the corresponding description part of the present disclosure. Accordingly, the terms used in the present disclosure should be defined based on the meanings of the terms and the entire contents of the present disclosure rather than simply by the names of the terms.

Singular expressions include plural expressions unless the context clearly indicates otherwise. In the present disclosure, terms such as “comprise”, “include”, or “have” are intended to designate the presence of features, numbers, steps, operations, components, parts, or combinations thereof described in the specification, but it should be understood that they do not preclude in advance the possibility of the presence or addition of one or more other features, numbers, steps, operations, components, parts, or combinations thereof.

Hereinafter, exemplary embodiments will be described in detail with reference to the accompanying drawings, in which like reference numerals refer to like or corresponding elements throughout the figures, and repetitive descriptions thereof will be omitted.

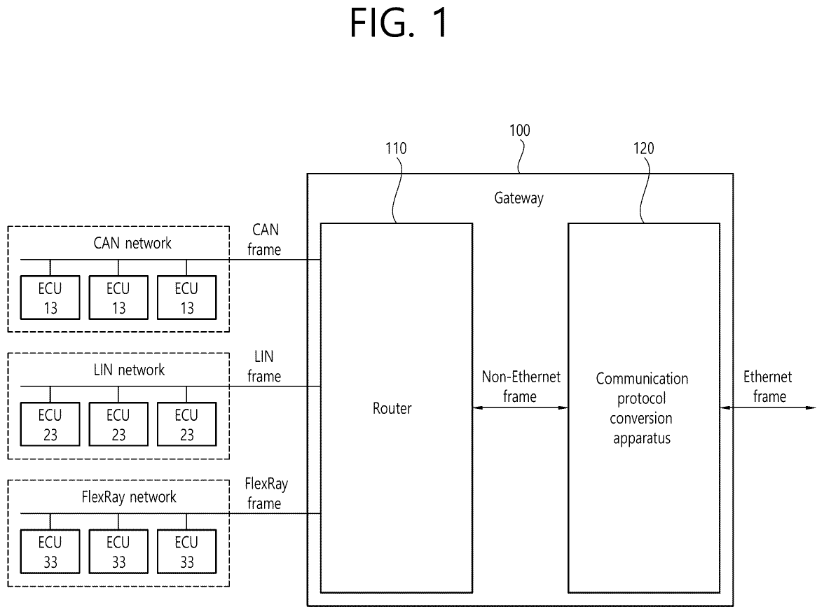

FIG. 1 is a view showing an operation of a gateway between heterogeneous automobile communication networks that includes a communication protocol conversion apparatus 120 according to an embodiment of the present disclosure.

As illustrated in FIG. 1, a gateway 100 between heterogeneous automobile communication networks that includes a communication protocol conversion apparatus according to an embodiment of the present disclosure includes a router 110 and the communication protocol conversion apparatus 120. However, not all of the illustrated components are essential components. The gateway 100 between heterogeneous automobile communication networks may be implemented by more components than the illustrated ones, or the gateway 100 between heterogeneous automobile communication networks may be implemented by fewer components.

As illustrated in FIG. 1, the gateway 100 between heterogeneous automobile communication networks is connected between an Ethernet network, which is a vehicle backbone network, and multiple non-Ethernet networks (e.g., CAN network, LIN network, FlexRay network, etc.) to mediate between heterogeneous automobile communication networks. A specific electronic control unit (ECU) belonging to a non-Ethernet network may communicate with an electronic control unit (ECU) belonging to another non-Ethernet via the gateway 100.

To this end, the gateway 100 between heterogeneous automobile communication networks according to an embodiment of the present disclosure includes a router 110 and a communication protocol conversion apparatus 120. Here, the communication protocol conversion apparatus 120 may detect communication protocol conversion errors between heterogeneous automobile communication networks.

The router 110 may route multiple non-Ethernet networks to an Ethernet network through the communication protocol conversion apparatus 120, or may route an Ethernet network to a non-Ethernet network through the communication protocol conversion apparatus 120.

The communication protocol conversion apparatus 120 may convert communication protocols for heterogeneous automobile communication networks by converting a non-Ethernet frame into an Ethernet frame or converting an Ethernet frame into a non-Ethernet frame.

Here, the communication protocol conversion apparatus 120 may detect errors arising when a communication protocol conversion module implemented as hardware or software converts communication protocols. For example, as illustrated in FIG. 1, the communication protocol conversion apparatus 120 may store a copy of a non-Ethernet frame inputted from the router 110, convert the input non-Ethernet frame into an Ethernet frame, inversely convert the converted Ethernet frame into a non-Ethernet frame, compare the stored copy of the non-Ethernet frame and the inversely converted non-Ethernet frame, and detect a conversion error between the non-Ethernet and Ethernet networks according to a comparison result.

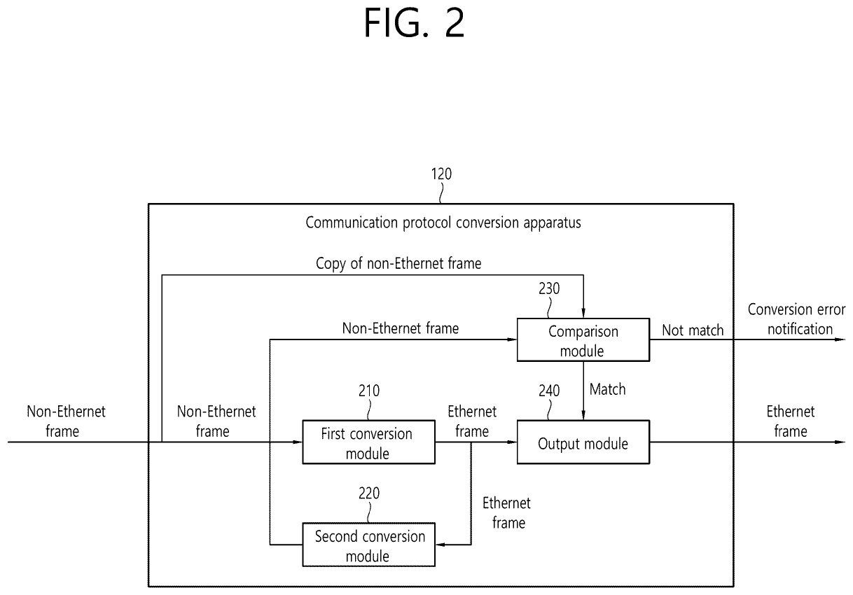

FIG. 2 is a view showing an operation of detecting conversion errors when converting a non-Ethernet frame into an Ethernet frame by a communication protocol conversion apparatus according to an embodiment of the present disclosure.

As illustrated in FIG. 2, the communication protocol conversion apparatus 120 according to an embodiment of the present disclosure may detect conversion errors when converting a non-Ethernet frame into an Ethernet frame.

To this end, the communication protocol conversion apparatus 120 transmits an input non-Ethernet frame to a first conversion module 210 and stores a copy of the non-Ethernet frame.

Then, the first conversion module 210 converts the transmitted non-Ethernet frame into an Ethernet frame. The converted Ethernet frame is transmitted to a second conversion module 220 and an output module 240.

Subsequently, the second conversion module 220 inversely converts the converted Ethernet frame into a non-Ethernet frame.

Afterwards, a comparison module 230 compares the stored copy of the non-Ethernet frame and the inversely converted non-Ethernet frame.

If the comparison result shows that the stored copy of the non-Ethernet frame and the inversely converted non-Ethernet frame match, the output module 240 outputs the transmitted Ethernet frame.

Conversely, if the comparison result shows that the stored copy of the non-Ethernet frame and the inversely converted non-Ethernet frame do not match, the comparison module 230 issues a conversion error notification.

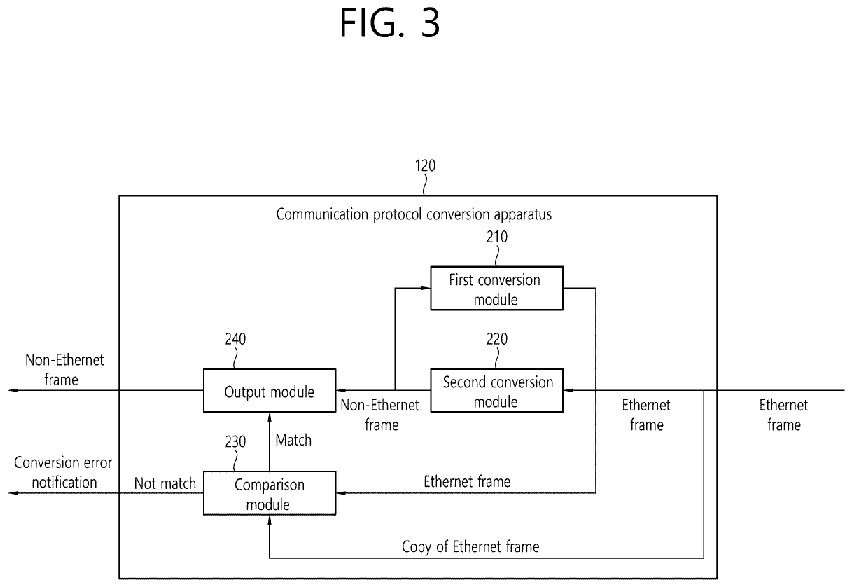

FIG. 3 is a view showing an operation of detecting conversion errors when converting an Ethernet frame into a non-Ethernet frame by a communication protocol conversion apparatus according to an embodiment of the present disclosure.

As illustrated in FIG. 3, the communication protocol conversion apparatus 120 according to an embodiment of the present disclosure may detect conversion errors when converting an Ethernet frame into a non-Ethernet frame.

To this end, the communication protocol conversion apparatus 120 transmits an input Ethernet frame to the second conversion module 220 and stores a copy of the Ethernet frame.

Then, the second conversion module 220 converts the transmitted Ethernet frame into a non-Ethernet frame. The converted non-Ethernet frame is transmitted to the first conversion module 210 and the output module 240.

Subsequently, the first conversion module 210 converts the inversely converted non-Ethernet frame into an Ethernet frame.

Afterwards, the comparison module 230 compares the stored copy of the Ethernet frame and the inversely converted Ethernet frame.

If the comparison result shows that the stored copy of the Ethernet frame and the inversely converted Ethernet frame match, the output module 240 outputs the transmitted non-Ethernet frame.

Conversely, if the comparison result shows that the stored copy of the Ethernet frame and the inversely converted Ethernet frame do not match, the comparison module 230 issues a conversion error notification.

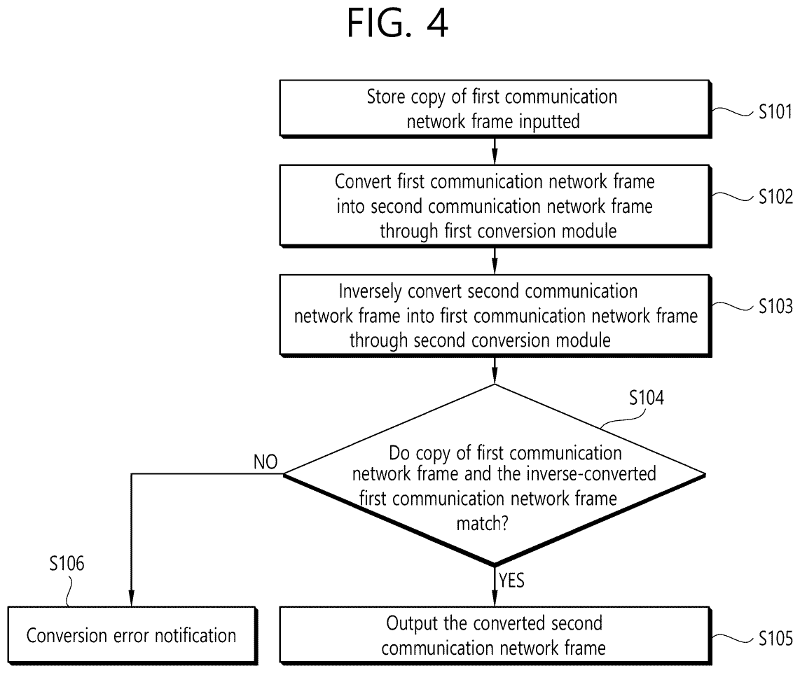

FIG. 4 is a flowchart showing a communication protocol conversion method for detecting communication protocol conversion errors between heterogeneous automobile communication networks according to an embodiment of the present disclosure.

In step S101, the communication protocol conversion apparatus 120 stores a copy of a first communication network frame received.

In step S102, the communication protocol conversion apparatus 120 converts the first communication network frame into a second communication network frame through the first conversion module 210. Here, if the first communication network frame is a non-Ethernet frame, then the second communication network frame is an Ethernet frame, and if the first communication network frame is an Ethernet frame, then the second communication network frame is a non-Ethernet frame.

In step S103, the communication protocol conversion apparatus 120 inversely converts the second communication network frame into a first communication network frame through the second conversion module 220.

In step S104, the communication protocol conversion apparatus 120 compares the stored copy of the first communication network frame and the inversely converted first communication network frame.

In step S105, if a comparison result shows that the stored copy of the first communication network frame and the inversely converted first communication network frame match and therefore no conversion error is detected, the communication protocol conversion apparatus 120 outputs the converted second communication network frame.

On the other hand, in step S106, if the comparison result shows that the stored copy of the first communication network frame and the inversely converted first communication network frame do not match and therefore a conversion error is detected, the communication protocol conversion apparatus 120 issues a conversion error notification.

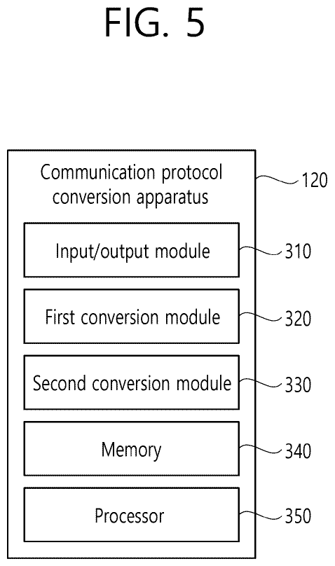

FIG. 5 is a configuration diagram of a communication protocol conversion apparatus for detecting communication protocol conversion errors between heterogeneous automobile communication networks according to an embodiment of the present disclosure.

As illustrated in FIG. 5, the communication protocol conversion apparatus 120 for detecting communication protocol conversion errors between heterogeneous automobile communication networks according to an embodiment of the present disclosure includes an input/output module 310, a first conversion module 210, a second conversion module 220, a memory 340, and a processor 350. However, not all of the illustrated components are essential components. The communication protocol conversion apparatus 120 for detecting communication protocol conversion errors between heterogeneous automobile communication networks may be implemented by more components than the illustrated ones, or the communication protocol conversion apparatus 120 for detecting communication protocol conversion errors between heterogeneous automobile communication networks may be implemented by fewer components.

Hereinafter, detailed configurations and operations of the components of the communication protocol conversion apparatus 120 of FIG. 5 for detecting communication protocol conversion errors between heterogeneous automobile communication networks will be described.

The input/output module 310 is connected to a first communication network and a second communication network. The input/output module 310 may receive a first communication network frame from the first communication network or transmit it, and may receive a second communication network frame from the second communication network or transmit it.

The first conversion module 320 converts a first communication network frame into a second communication network frame, in order to convert communication protocols between heterogeneous communication networks.

The second conversion module 330 converts a second communication network frame into a first communication network frame, in order to convert communication protocols between heterogeneous communication networks.

The memory 340 stores one or more programs related to a communication protocol conversion operation for detecting communication protocol conversion errors between heterogeneous automobile communication networks.

The processor 350 executes one or more programs stored in the memory 340. The processor 350 may store a copy of a first communication network frame received through the input/output module 310, convert the received first communication network frame into a second communication network frame through the first conversion module 320, convert the inversely converted second communication network frame into a first communication network frame through the second conversion module 330, compare the stored copy of the first communication network frame and the inversely converted first communication network frame, and detect a conversion error according to a comparison result.

According to embodiments, if the first communication network frame is a non-Ethernet frame, then the second communication network frame is an Ethernet frame, and if the first communication network frame is an Ethernet frame, then the second communication network frame is a non-Ethernet frame.

According to embodiments, the non-Ethernet frame may include at least one of a CAN (controller area network) frame, a LIN (local interconnect network) frame, and a FlexRay frame.

According to embodiments, if the comparison result shows that the stored copy of the first communication network frame and the inversely converted first communication network frame match and therefore no conversion error is detected, the processor 350 may output the converted second communication network frame.

According to embodiments, if the comparison result shows that the stored copy of the first communication network frame and the inversely converted first communication network frame do not match and therefore a conversion error is detected, the processor 350 may issue a conversion error notification.

According to embodiments, the processor 350 may detect errors arising when the first conversion module 320 or the second conversion module 330 reassembles control information (PDU; Protocol Data Unit) of an input frame into control information (PDU) of an output frame.

Meanwhile, according to an embodiment of the disclosure, the diverse embodiments described above may be implemented by software including instructions that are stored in machine (e.g., a computer)-readable storage media. The machine is a device that invokes the stored instructions from the storage media and is operable according to the invoked instructions, and may include an electronic device (e.g., electronic device A) according to the disclosed embodiments. When the instructions are executed by the processor, the processor may perform functions corresponding to the instructions, either directly by the processor or using other components under the control of the processor. The instructions may include codes generated or executed by a compiler or an interpreter. The machine-readable storage media may be provided in the form of non-transitory storage media. Here, the term ‘non-transitory’ means that the storage medium does not include a signal and is tangible, but does not distinguish whether data is stored semi-permanently or temporarily in the storage medium.

In addition, according to an embodiment of the disclosure, the method according to the diverse embodiments described above may be included and provided in a computer program product. The computer program product may be traded as a product between a seller and a purchaser. The computer program product may be distributed in the form of a machine readable storage medium (e.g., a compact disc read only memory (CD-ROM)), or distributed online through an application store (e.g., PlayStore™). In the case of the online distribution, at least a portion of the computer program product may be at least temporarily stored in a storage medium such as a memory of a server of a manufacturer, a server of an application store, or a relay server, or be temporarily generated.

In addition, according to an embodiment of the disclosure, the diverse embodiments described above may be implemented in a recording medium readable by a computer or similar device, by using software, hardware, or a combination thereof. In some cases, the embodiments described in the disclosure may be implemented by the processor itself. According to a software implementation, the embodiments such as procedures and functions described in the disclosure may be implemented as separate software modules. Each of the software modules may perform one or more functions and operations described in the disclosure.

Meanwhile, computer instructions for performing processing operations of the device according to the diverse embodiments described above may be stored in a non-transitory computer-readable medium. The computer instructions stored in the non-transitory computer-readable medium allow a specific device to perform the processing operations of the device according to the diverse embodiments described above when being executed by a processor of the specific device. The non-transitory computer-readable medium is not a medium that stores data for a short time such as a register, a cache, a memory, or the like, but means a machine readable medium that semi-permanently stores data. A specific example of the non-transitory computer-readable medium may include a compact disc (CD), a digital versatile disc (DVD), a hard disk, a Blu-ray disc, a universal serial bus (USB), a memory card, a read only memory (ROM), or the like.

In addition, each of the components (e.g., modules or programs) according to the diverse embodiments described above may include a single entity or a plurality of entities, and some sub-components of the sub-components described above may be omitted, or other sub-components may be further included in the diverse embodiments. Alternatively or additionally, some components (e.g., modules or programs) may be integrated into one entity to perform the same or similar functions performed by the respective components prior to the integration. The operations performed by the module, the program, or other component according to the diverse embodiments may be performed in a sequential, parallel, iterative, or heuristic manner, or at least some operations may be executed in a different order or omitted, or other operations may be added.

While exemplary embodiments of the disclosure have been shown and described, the disclosure is not limited to the aforementioned specific embodiments, and various modifications can be made by those having ordinary skill in the art to which the disclosure belongs, without departing from the gist of the disclosure as claimed by the appended claims. Also, it is intended that such modifications are not to be interpreted independently from the technical idea or prospect of the present disclosure.

What is claimed is:

1. A communication protocol conversion method for detecting communication protocol conversion errors between heterogeneous automobile communication networks, performed by a communication protocol conversion apparatus, the method comprising:
storing a copy of a first communication network frame received;
converting the received first communication network frame into a second communication network frame through a first conversion module;
inversely converting the converted second communication network frame into a first communication network frame through a second conversion module;
comparing the stored copy of the first communication network frame and the inversely converted first communication network frame; and
detecting conversion errors between the first and second communication network frames according to a comparison result.

2. The method of claim 1, wherein, if the first communication network frame is a non-Ethernet frame, then the second communication network frame is an Ethernet frame, and if the first communication network frame is an Ethernet frame, then the second communication network frame is a non-Ethernet frame.

3. The method of claim 2, wherein the non-Ethernet frame includes at least one of a CAN (controller area network) frame, a LIN (local interconnect network) frame, and a FlexRay frame.

4. The method of claim 1, wherein, in the detecting of conversion errors, if the comparison result shows that the stored copy of the first communication network frame and the inversely converted first communication network frame do not match, a conversion error notification is issued.

5. The method of claim 1, wherein, in the detecting of conversion errors, if the comparison result shows that the stored copy of the first communication network frame and the inversely converted first communication network frame match, the converted second communication network frame is outputted.

6. The method of claim 1, wherein, in the detecting of conversion errors, errors arising when the first conversion module or the second conversion module reassembles control information (PDU; Protocol Data Unit) format of an input frame into control information (PDU) format of an output frame are detected.

7. A communication protocol conversion apparatus for detecting communication protocol conversion errors between heterogeneous automobile communication networks, the apparatus comprising:
an input/output module that receives or transmits a communication network frame between the heterogeneous automobile communication networks;
a first conversion module that converts a first communication network frame into a second communication network frame, between the heterogeneous automobile communication networks;
a second conversion module that converts the second communication network frame into the first communication network frame, between the heterogeneous automobile communication networks;
a memory that stores one or more programs; and
a processor that executes the one or more stored programs;
wherein the processor stores a copy of the first communication network frame received through the input/output module, converts the received first communication network frame into the second communication network frame through the first conversion module, inversely converts the converted second communication network frame into a first communication network frame through the second conversion module, compares the stored copy of the first communication network frame and the inversely converted first communication network frame, and detects conversion errors between the first and second communication network frames according to a comparison result.

8. The apparatus of claim 7, wherein, if the first communication network frame is a non-Ethernet frame, then the second communication network frame is an Ethernet frame, and if the first communication network frame is an Ethernet frame, then the second communication network frame is a non-Ethernet frame.

9. The apparatus of claim 8, wherein the non-Ethernet frame includes at least one of a CAN (controller area network) frame, a LIN (local interconnect network) frame, and a FlexRay frame.

10. The apparatus of claim 7, wherein, if the comparison result shows that the stored copy of the first communication network frame and the inversely converted first communication network frame do not match, the processor issues a conversion error notification.

11. The apparatus of claim 7, wherein, if the comparison result shows that the stored copy of the first communication network frame and the inversely converted first communication network frame match, the processor outputs the converted second communication network frame.

12. The apparatus of claim 7, wherein the processor detects errors arising when the first conversion module or the second conversion module reassembles control information (PDU; Protocol Data Unit) format of an input frame into control information (PDU) format of an output frame.
